(19) United States
(12) Patent Application Publication
(10) Pub. No.: US 2020/0130695 A1
(43) Pub. Date: Apr. 30, 2020

(54) HYBRID VEHICLE

(71) Applicant: TOYOTA JIDOSHA KABUSHIKI KAISHA, Toyota-shi (JP)

(72) Inventors: Yuya ANDO, Toyota-shi (JP); Takeaki SUZUKI, Toyota-shi (JP); Shinsuke IWASAKI, Toyota-shi (JP); Miki SUGITA, Toyota-shi (JP)

(73) Assignee: TOYOTA JIDOSHA KABUSHIKI KAISHA, Toyota-shi (JP)

(21) Appl. No.: 16/660,997

(22) Filed: Oct. 23, 2019

(30) Foreign Application Priority Data
Oct. 24, 2018 (JP) 2018-199649

(51) Int. Cl. B60W 30/192; B60K 6/26; B60K 6/28; B60R 16/033; B60W 20/00; B60W 10/06; B60W 10/08; F02N 11/08

(52) U.S. Cl. CPC B60W 30/192; B60K 6/26; B60K 6/28; B60R 16/033; B60W 20/00; F02N 2200/022; B60W 10/08; F02N 11/0848; F02N 11/0862; B60Y 2200/92; B60Y 2300/192; B60W 10/06

(57) ABSTRACT

At a cold start of an engine, a hybrid vehicle is configured to perform first cranking control that controls a starter and an electric power transmission device, such that the engine is cranked by the starter using electric power from a first power storage device and a second power storage device, or to perform second cranking control that controls a motor generator and the electric power transmission device, such that the engine is cranked by the motor generator using the electric power from the first power storage device and the second power storage device.

### CROSS-REFERENCE TO RELATED APPLICATIONS

The present disclosure claims priority to Japanese Patent Application No. 2018-199649 filed Oct. 24, 2018, which is incorporated herein by reference in its entirety including specification, drawings and claims.

### Technical Field

The present disclosure relates to a hybrid vehicle.

### BACKGROUND

A proposed configuration of a hybrid vehicle includes an engine; a starter configured to crank the engine; a motor generator connected with the engine via a clutch; a low voltage battery electrically connected with the starter; a high voltage battery electrically connected with the motor generator; and a DC-DC converter provided between a first power line which the low voltage battery is connected with and a second power line which the high voltage battery is connected with (as described in, for example, JP 2017-217943A). At a cold start of the engine, this hybrid vehicle causes the engine to be cranked by the starter using the electric power from the low voltage battery, simultaneously with turning on a first clutch and causing the engine to be cranked by the motor generator using the electric power from the high voltage battery. In other words, the engine is cranked by both the starter and the motor generator. This configuration allows a starter of a low torque to be employed for the starter of the hybrid vehicle.

The hybrid vehicle described above requires to make cooperation between a cranking torque of the starter and a cranking torque of the motor generator to be suitable for cranking the engine at a cold start of the engine. This causes complicated control. There is accordingly a need to start the engine by the simpler control at a cold start of the engine.

### SUMMARY

A main object of a hybrid vehicle of the present disclosure is to start an engine by simpler control at a cold start of the engine.

In order to achieve the main object described above, the present disclosure is implemented by aspects of a hybrid vehicle described above.

According to one aspect of the present disclosure, there is provided a hybrid vehicle including an engine, a starter configured to crank the engine, a motor generator connected with the engine, a first power storage device connected with the starter via a first power line, a second power storage device connected with the motor generator via a second power line, an electric power transmission device configured to transmit electric power between the first power line and the second power line and to cancel the transmission, and a control device configured to control the engine, the starter and the motor generator. At a cold start of the engine, the control device performs first cranking control that controls the starter and the electric power transmission device, such that the engine is cranked by the starter using electric power from the first power storage device and the second power storage device, or the control device performs second cranking control that controls the motor generator and the electric power transmission device, such that the engine is cranked by the motor generator using the electric power from the first power storage device and the second power storage device.

At a cold start of the engine, the hybrid vehicle according to this aspect of the present disclosure performs the first cranking control that controls the starter and the electric power transmission device, such that the engine is cranked by the starter using the electric power from the first power storage device and the second power storage device, or performs the second cranking control that controls the motor generator and the electric power transmission device, such that the engine is cranked by the motor generator using the electric power from the first power storage device and the second power storage device. In other words, at a cold start of the engine, the engine is cranked by either the starter or the motor generator using the electric power from the first power storage device and the second power storage device. This configuration enables the engine to be started by the simpler control, compared with a configuration that cranks the engine by both the starter and the motor generator at a cold start of the engine.

In the hybrid vehicle according to the above aspect of the present disclosure, the starter may be a DC series-wound type, the motor generator may be a DC shunt-wound type, and the control device may perform the first cranking control at the cold start of the engine. The engine has a large rotational resistance in its rotation stop state and starts decreasing the rotational resistance at a start of rotation. Regarding the starter and the motor generator, the DC series-wound type is characterized by outputting a larger torque in the rotation stop state, compared with the DC shunt-wound type. Accordingly, the configuration of performing the first cranking control at a cold start of the engine enables the rotation speed of the engine to be more reliably raised from a value 0, compared with a configuration of performing the second cranking control.

In this case, in the hybrid vehicle according to the above aspect of the present disclosure, the control device may change over control from the first cranking control to the second cranking control, when a rotation speed of the engine does not reach a start completion rotation speed by the first cranking control at the cold start of the engine. The DC shunt-wound type is characterized by the higher output (i.e., the smaller decrease in torque with an increase in rotation speed) than the DC series-wound type. Accordingly, when the rotation speed of the engine does not reach the start completion rotation speed by the first cranking control, the second cranking control is performed to cause the rotation speed of the engine to more reliably reach the start completion rotation speed.

### BRIEF DESCRIPTION OF DRAWINGS

FIG. 1 is a configuration diagram illustrating one exemplary configuration of a hybrid vehicle according to one embodiment of the present disclosure;

FIG. 2 is a flowchart showing one example of a cranking control routine performed by ECU;

FIG. 3 is a diagram illustrating one example of the process of starting an engine;

FIG. 4 is a flowchart showing one example of a cranking control routine according to a modification;

FIG. 5 is a diagram illustrating one example of the process of starting the engine according to the modification; and

FIG. 6 is a configuration diagram illustrating a schematic configuration of a hybrid vehicle according to a modification.

### DESCRIPTION OF EMBODIMENTS

The following describes some aspects of the present disclosure with reference to an embodiment.

### Embodiment

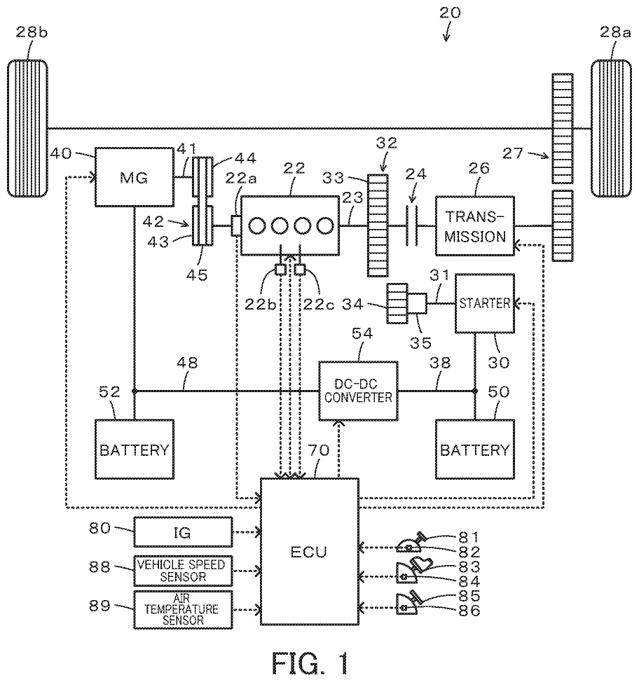

FIG. 1 is a configuration diagram illustrating the schematic configuration of a hybrid vehicle 20 according to one embodiment of the present disclosure. As illustrated, the hybrid vehicle 20 of the embodiment includes an engine 22, a clutch 24, a transmission 26, a starter 30, a gear mechanism 32, a motor generator 40, a belt mechanism 42, batteries 50 and 52, a DC-DC converter 54, and an electronic control unit (hereinafter referred to as “ECU”) 70.

The engine 22 is configured as an internal combustion engine that outputs power using, for example, gasoline or light oil as a fuel. The clutch 24 is configured as, for example, a hydraulically-operated friction clutch and serves to connect and disconnect a crankshaft 23 of the engine 22 with and from an input shaft of the transmission 26.

The transmission 26 is configured as, for example, a 10-speed automatic transmission and includes an input shaft, an output shaft, a plurality of planetary gears, and a plurality of hydraulically-operated frictional engagement elements (clutches and brakes). The input shaft is connected with the engine 22 via the clutch 24, and the output shaft is connected with drive wheels 28a and 28b via a speed reducer 27. This transmission 26 generates first to tenth forward speeds and reverse speeds by engagement and disengagement of the plurality of frictional engagement elements and transmits power between the input shaft and the output shaft. The transmission 26 is, however, not limited to the 10-speed transmission but may be a 4-speed transmission, a 5-speed transmission, a 6-speed transmission or an 8-speed transmission.

The starter 30 is configured as a DC series-wound motor and is connected with a power line 38. The gear mechanism 32 includes a ring gear 33 that has external teeth and that is mounted to the crankshaft 23 of the engine 22; a pinion gear 34 that integrally rotates with a rotating shaft 31 of the starter 30; and an actuator 35 that moves the pinion gear 34 in an axial direction thereof to engage and disengage the pinion gear 34 with and from the ring gear 33.

The motor generator 40 is configured as a DC shunt-wound motor generator and is connected with a power line 48. The belt mechanism 42 includes a pulley 43 that is mounted to the crankshaft 23 of the engine 22; a pulley 44 that is mounted to a rotating shaft 41 of the motor generator 40; and a belt 45 that is spanned between the pulley 43 and the pulley 44.

The battery 50 is configured as, for example, a lead acid battery having a rated voltage of 12 V and is connected with the power line 38. The battery 52 is configured as, for example, a nickel metal hydride battery or a lithium ion rechargeable battery having a rated voltage of about 40 V to 50 V and is connected with the power line 48. The DC-DC converter 54 is connected with the power line 38 and with the power line 48 and is configured to step up the voltage of electric power of the power line 38 and supply the electric power of the stepped-up voltage to the power line 48 and to step down the voltage of the electric power of the power line 48 and supply the electric power of the stepped-down voltage to the power line 38.

The ECU 70 is configured as a CPU-based microprocessor and includes a ROM configured to store processing programs, a RAM configured to temporarily store data and input/output ports, in addition to the CPU. Signals from various sensors are input into the ECU 70 via the input port. The signals input into the ECU 70 include, for example, a rotation speed Ne of the engine 22 from a rotation speed sensor 22a, a cooling water temperature Tw indicating the temperature of cooling water in the engine 22 from a water temperature sensor 22b, and an oil temperature To indicating the temperature of lubricating oil for lubricating and cooling the engine 22 from an oil temperature sensor 22c. The input signals also include voltages Vb1 and Vb2 of the batteries 50 and 52 from voltage sensors placed between respective terminals of the batteries 50 and 52 and electric currents Ib1 and Ib2 of the batteries 50 and 52 from current sensors mounted to respective output terminals of the batteries 50 and 52. The input signals further include an ignition signal from an ignition switch 80 and a shift position SP from a shift position sensor 82 configured to detect an operating position of a shift lever 81. The input signals also include an accelerator position Acc from an accelerator pedal position sensor 84 configured to detect a depression amount of an accelerator pedal 83, a brake pedal position BP from a brake pedal position sensor 86 configured to detect a depression amount of a brake pedal 85, a vehicle speed V from a vehicle speed sensor 88, and an outside air temperature Ta from an outside air temperature sensor 89. Various control signals are output from the ECU 70 via the output port. The signals output from the ECU 70 include, for example, control signals to the engine 22, the transmission 26, the starter 30, the actuator 35, the motor generator 40 and the DC-DC converter 54.

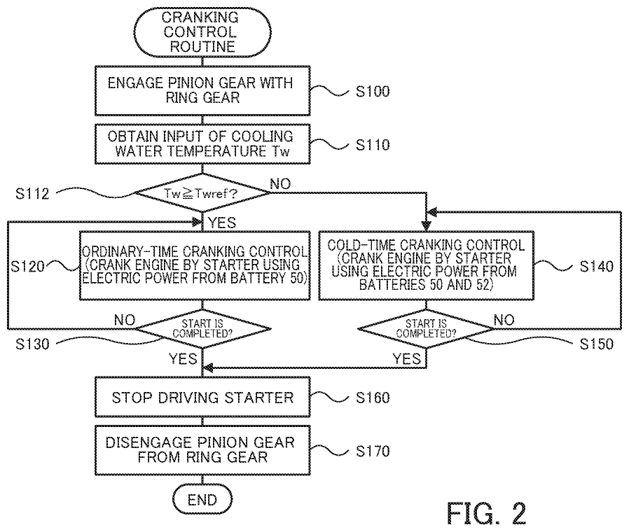

The following describes operations of the hybrid vehicle 20 of the embodiment having the configuration described above or more specifically a series of operations to start the engine 22. FIG. 2 is a flowchart showing one example of a cranking control routine performed by the ECU 70. This routine is triggered in response to a start instruction of the engine 22. In the process of starting the engine 22, the ECU 70 starts fuel injection control and ignition control of the engine 22 when the rotation speed Ne of the engine 22 becomes equal to or higher than an operation start rotation speed Nst during execution of the cranking control routine of FIG. 2. The operation start rotation speed Nst used may be, for example, about 500 to 700 rpm.

When the cranking control routine of FIG. 2 is triggered, the ECU 70 first controls the actuator 35, such that the pinion gear 34 is moved in its axial direction toward the ring gear 33 to engage with the ring gear 33 (step S100). The ECU 70 subsequently obtains the input of the cooling water temperature Tw of the engine 22 from the water temperature sensor 22b (step S110) and compares the input cooling water temperature Tw of the engine 22 with a reference value Twref (step S112). The reference value Twref herein denotes a threshold value used to determine whether the present state of the engine 22 is an ordinary start condition or a cold start condition and may be set to, for example, −5° C., 0° C. or 5° C.

When the cooling water temperature Tw of the engine 22 is equal to or higher than the reference value Twref at step S112, the ECU 70 determines that the present state of the engine 22 is an ordinary start condition and performs ordinary-time cranking control (step S120). The ordinary-time cranking control controls the starter 30, such that the engine 22 is cranked by the starter 30 using the electric power from the battery 50.

The ECU 70 subsequently determines whether a start of the engine 22 has been completed (step S130). When it is determined that the start of the engine 22 has not yet been completed, the ECU 70 returns the cranking control routine to step S120. When it is determined at step S130 that the start of the engine 22 has been completed during repetition of the processing of steps S120 and S130, the ECU 70 stops driving the starter 30 (step S160), controls the actuator 35, such that the pinion gear 34 is moved in its axial direction away from the ring gear 33 to be disengaged from the ring gear 33 (step S170), and then terminates this cranking control routine. It is herein determined that the start of the engine 22 has been completed when the rotation speed Ne of the engine 22 becomes equal to or higher than a start completion rotation speed Nco. The start completion rotation speed Nco used may be, for example, about 800 rpm to 1000 rpm.

When the cooling water temperature Tw of the engine 22 is lower than the reference value Twref at step S112, on the other hand, the ECU 70 determines that the present state of the engine 22 is a cold start condition and performs cold-time cranking control (step S140). The cold-time cranking control controls the starter 30 and the DC-DC converter 54, such that the engine 22 is cranked by the starter 30 using the electric power from the batteries 50 and 52. In this state, in addition to the supply of electric power from the battery 50 to the starter 30, the DC-DC converter 54 is driven, so that electric power is supplied from the battery 52 via the DC-DC converter 54 to the starter 30.

The ECU 70 subsequently determines whether a start of the engine 22 has been completed (step S150). When it is determined that the start of the engine 22 has not yet been completed, the ECU 70 returns the cranking control routine to step S140. When it is determined at step S150 that the start of the engine 22 has been completed during repetition of the processing of steps S140 and S150, the ECU 70 stops driving the starter 30 (step S160), controls the actuator 35, such that the pinion gear 34 is moved in its axial direction away from the ring gear 33 to be disengaged from the ring gear 33 (step S170), and then terminates this cranking control routine. The processing of step S150 is performed in a similar manner to the processing of step S130 described above.

As described above, at a cold start of the engine 22, the engine 22 is cranked by the starter 30 using the electric power from the batteries 50 and 52. This configuration enables the engine 22 to be cranked and started by the simpler control (i.e., by the control with no need to take into account cooperation of the cranking torque of the starter 30 and the cranking torque of the motor generator 40), compared with a configuration of cranking the engine 22 by the starter 30 and the motor generator 40.

Furthermore, cranking the engine 22 by the starter 30 out of the starter 30 and the motor generator 40 at a cold start of the engine 22 provides advantageous effects described below. The engine 22 has a large rotational resistance in its rotation stop state and starts decreasing the rotational resistance at a start of rotation, compared with the level in the rotation stop state. According to the embodiment, the starter 30 is configured as the DC series-wound motor, and the motor generator 40 is configured as the DC shunt-wound motor generator. The DC series-wound type is characterized by outputting a larger torque in the rotation stop state, compared with the DC shunt-wound type. Accordingly, the configuration of cranking the engine 22 by the starter 30 enables the rotation speed of the engine 22 to be more reliably raised from a value 0, compared with a configuration of cranking the engine 22 by the motor generator 40.

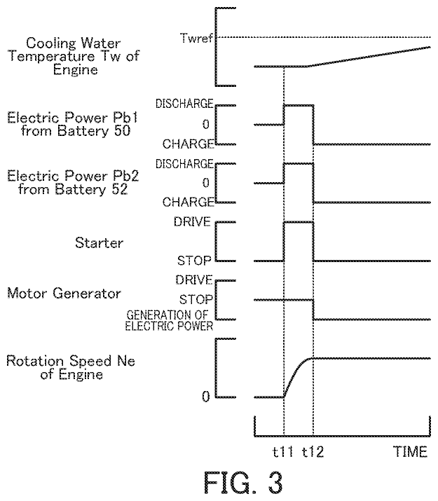

FIG. 3 is a diagram illustrating one example of the process of starting the engine 22. As illustrated, in response to a start instruction of the engine 22 (at a time t11), when the cooling water temperature Tw of the engine 22 is lower than the reference value Twref, the engine 22 is cranked to start by the starter 30 using the electric power from the batteries 50 and 52 (i.e., by the cold-time cranking control). On completion of the start of the engine 22 (at a time t12), the motor generator 40 is operated to generate electric power by using the power from the engine 22 to charge the battery 52, while the DC-DC converter 54 is driven to charge the battery 50.

As described above, the hybrid vehicle 20 of the embodiment causes the engine 22 to be cranked by the starter 30 using the electric power from the batteries 50 and 52 at a cold start of the engine 22. This configuration enables the engine 22 to be cranked and started by the simpler control (i.e., by the control with no need to take into account cooperation of the cranking torque of the starter 30 and the cranking torque of the motor generator 40), compared with a configuration of cranking the engine 22 by the starter 30 and the motor generator 40.

The hybrid vehicle 20 of the embodiment employs the DC series-wound type for the starter 30 and the DC shunt-wound type for the motor generator 40 and thereby causes the engine 22 to be cranked by the starter 30 using the electric power from the batteries 50 and 52 at a cold start of the engine 22. According to a modification that employs a DC series-wound motor generator for the motor generator 40, however, the engine 22 maybe cranked by the motor generator 40 using the electric power from the batteries 50 and 52 at a cold start of the engine 22.

The hybrid vehicle 20 of the embodiment causes the engine 22 to be cranked by the starter 30 using the electric power from the battery 50 at an ordinary start of the engine 22. At the ordinary start of the engine 22, however, the engine 22 does not have a relatively large rotational resistance. According to a modification, even when the DC shunt-wound motor generator is employed for the motor generator 40, the engine 22 may be cranked by the motor generator 40 using the electric power from the battery 52.

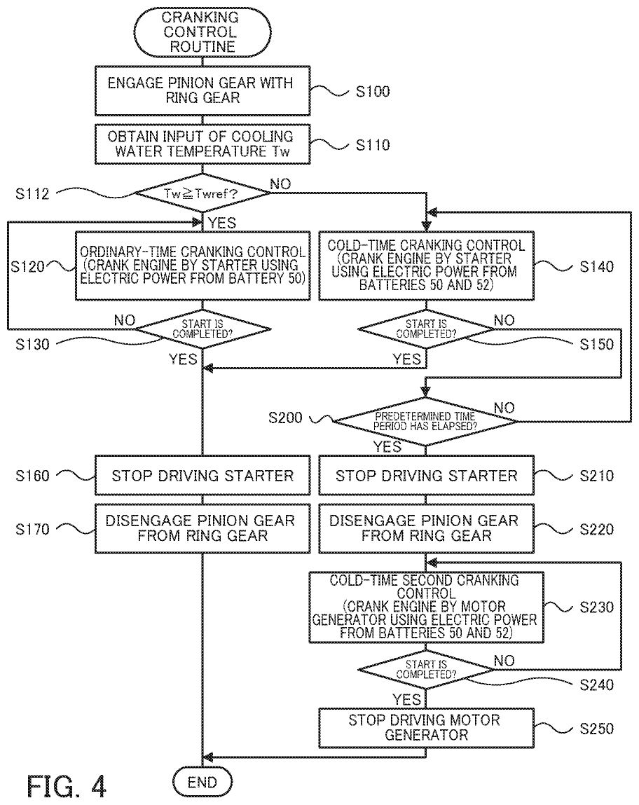

In the hybrid vehicle 20 of the embodiment, the ECU 70 performs the cranking control routine of FIG. 2. According to a modification, the ECU 70 may perform a cranking control routine of FIG. 4, in place of the cranking control routine of FIG. 2. The cranking control routine of FIG. 4 is similar to the cranking control routine of FIG. 2, except addition of the processing of steps S200 to S250. The like processing steps are expressed by the like step numbers, and their detailed description is omitted.

In the cranking control routine of FIG. 4, when it is determined at step S150 that the start of the engine 22 has not yet been completed, the ECU 70 subsequently determines whether a predetermined time period has elapsed since a start of cranking of the engine 22 by the starter 30 (i.e., whether cranking of the engine 22 by the starter 30 continues for a predetermined time period) (step S200). When it is determined that the predetermined time period has not yet elapsed since the start of cranking of the engine 22 by the starter 30, the ECU 70 returns the cranking control routine to step S140. The predetermined time period used may be, for example, several hundred msec.

During repetition of the processing of steps S140 to S200, when it is determined at step S200 that the predetermined time period has elapsed since the start of cranking of the engine 22 by the starter 30, prior to the determination of completion of the start of the engine 22 at step S150, the ECU 70 stops driving the starter 30 (step S210), controls the actuator 35, such that the pinion gear 34 is moved in its axial direction away from the ring gear 33 to be disengaged from the ring gear 33 (step S220), and then performs cold-time second cranking control (step S230). In other words, the cold-time cranking control is changed over to the cold-time second cranking control. The cold-time second cranking control controls the motor generator 40 and the DC-DC converter 54, such that the engine 22 is cranked by the motor generator 40 using the electric power from the batteries 50 and 52. In this state, in addition to the supply of electric power from the battery 52 to the motor generator 40, the DC-DC converter 54 is driven, so that electric power is supplied from the battery 50 via the DC-DC converter 54 to the motor generator 40.

The ECU 70 subsequently determines whether a start of the engine 22 has been completed (step S240). When it is determined that the start of the engine 22 has not yet been completed, the ECU 70 returns the cranking control routine to step S230. When it is determined at step S240 that the start of the engine 22 has been completed during repetition of the processing of steps S230 and S240, the ECU 70 stops driving the motor generator 40 (step S250) and then terminates the cranking control routine. The processing of step S240 is performed in a similar manner to the processing of step S150 described above.

According to this modification, at a cold start of the engine 22, when the rotation speed Ne of the engine 22 does not become equal to or higher than the start completion rotation speed Nco in the course of cranking of the engine 22 by the starter 30 using the electric power from the batteries 50 and 52, the engine 22 is cranked by the motor generator 40 using the electric power from the batteries 50 and 52. With regard to the starter 30 and the motor generator 40, the DC shunt-wound type is characterized by the higher output (i.e., the smaller decrease in torque with an increase in rotation speed) than the DC series-wound type. Accordingly, this control enables the rotation speed Ne of the engine 22 to more reliably reach the start completion rotation speed Nco.

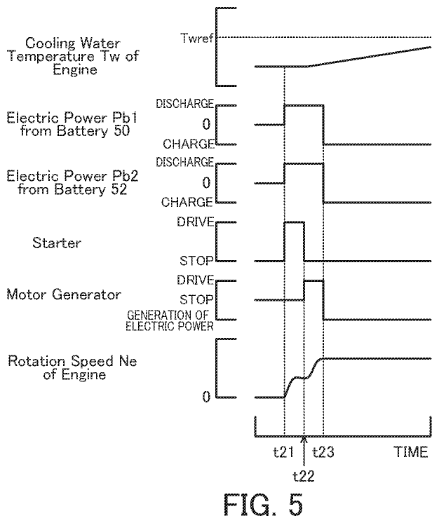

FIG. 5 is a diagram illustrating one example of the process of starting the engine 22 according to this modification. As illustrated, in response to a start instruction of the engine 22 (at a time t21), when the cooling water temperature Tw of the engine 22 is lower than the reference value Twref, the engine 22 is supposed to be cranked and started by the starter 30 using the electric power from the batteries 50 and 52 (i.e., by the cold-time cranking control). When the rotation speed Ne of the engine 22 has not reached the start completion rotation speed Nco even after elapse of the predetermined time period (at a time t22), the engine 22 is cranked and started by the motor generator 40 using the electric power from the batteries 50 and 52 (i.e., by the cold-time second cranking control). On completion of the start of the engine 22 (at a time t23), the motor generator 40 is operated to generate electric power by using the power from the engine 22 to charge the battery 52, while the DC-DC converter 54 is driven to charge the battery 50.

The hybrid vehicle 20 of the embodiment determines whether the present state of the engine 22 is an ordinary start condition or a cold start condition by comparison between the cooling water temperature Tw of the engine 22 and the reference value Twref. A modification may make the determination by comparison between the oil temperature To of the engine 22 and a reference value Toref or may make the determination by comparison between the outside air temperature Ta and a reference value Taref. The reference value Toref or the reference value Taref used herein may be determined in a similar manner to the reference value Twref. Another modification may make the determination by using multiple factors out of the cooling water temperature Tw and the oil temperature To of the engine 22 and the outside air temperature Ta.

In the hybrid vehicle 20 of the embodiment, the engine 22 and the motor generator 40 are connected with each other via the belt mechanism 42. According to a modification, the engine 22 and the motor generator 40 may be connected with each other via a gear mechanism or may be connected directly with each other.

The hybrid vehicle 20 of the embodiment uses the battery 50 as the first power storage device. A modification may use a capacitor as the first power storage device, instead of the battery 50. The hybrid vehicle 20 of the embodiment uses the battery 52 as the second power storage device. A modification may use a capacitor as the second power storage device, instead of the battery 52.

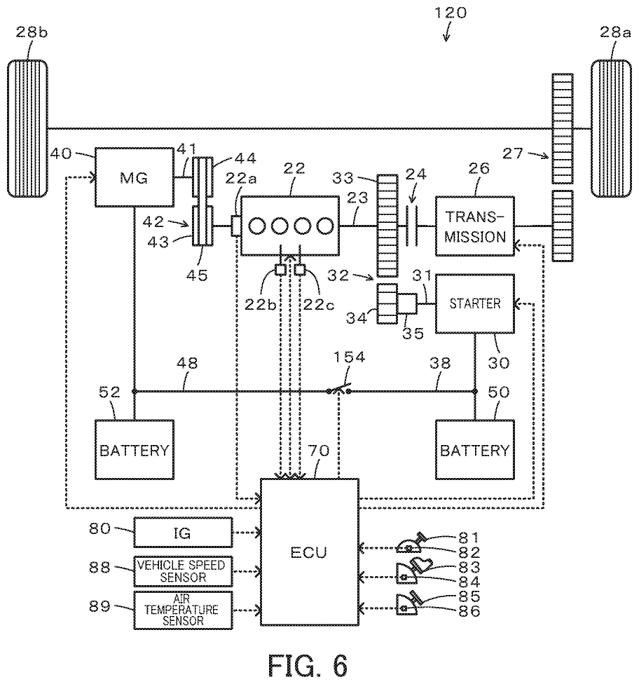

The hybrid vehicle 20 of the embodiment is provided with the engine 22, the starter 30, the motor generator 40, the batteries 50 and 52 and the DC-DC converter 54 as shown in FIG. 1. In the case where the batteries 50 and 52 have an identical rated voltage (for example, when both the batteries 50 and 52 have a rated voltage of 12 V), the DC-DC converter 54 may be replaced by a switch 154 like a hybrid vehicle 120 of a modification shown in FIG. 6.

The following describes the correspondence relationship between the primary components of the embodiment and the primary components of the disclosure described in Summary. The engine 22 of the embodiment corresponds to the “engine”, the starter 30 corresponds to the “starter”, the motor generator 40 corresponds to the “motor generator”, the battery 50 corresponds to the “first power storage device”, the battery 52 corresponds to the “second power storage device”, the DC-DC converter 54 corresponds to the “electric power transmission device” and the ECU 70 corresponds to the “control device” in the above aspect of the present disclosure.

The correspondence relationship between the primary elements of the above embodiment and the primary elements in the above aspects of the present disclosure described in Summary, however, does not intend to limit the elements in the aspects of the present disclosure described in Summary, since the above embodiment is only one example for concretely describing some aspects of the present disclosure described in Summary. In other words, the aspects of the present disclosure described in Summary should be construed on the basis of the description in Summary. The embodiment is only one concrete example of the present disclosure described in Summary.

Some aspects of the present disclosure are described above with reference to the embodiment and its modifications. The present disclosure is, however, not limited to any of the embodiment and its modifications described above but may be implemented by any of various other aspects within the scope of the present disclosure.

### INDUSTRIAL APPLICABILITY

The present disclosure is applicable to the manufacturing industries of the hybrid vehicle and so on.

What is claimed is:

1. A hybrid vehicle, comprising:
an engine;
a starter configured to crank the engine;
a motor generator connected with the engine;
a first power storage device connected with the starter via a first power line;
a second power storage device connected with the motor generator via a second power line;
an electric power transmission device configured to transmit electric power between the first power line and the second power line and to cancel the transmission; and
a control device configured to control the engine, the starter and the motor generator, wherein
at a cold start of the engine,
the control device performs first cranking control that controls the starter and the electric power transmission device, such that the engine is cranked by the starter using electric power from the first power storage device and the second power storage device, or
the control device performs second cranking control that controls the motor generator and the electric power transmission device, such that the engine is cranked by the motor generator using the electric power from the first power storage device and the second power storage device.

2. The hybrid vehicle according to claim 1,
wherein the starter is a DC series-wound type,
the motor generator is a DC shunt-wound type, and
the control device performs the first cranking control at the cold start of the engine.

3. The hybrid vehicle according to claim 2,
wherein the control device changes over control from the first cranking control to the second cranking control, when a rotation speed of the engine does not reach a start completion rotation speed by the first cranking control at the cold start of the engine.
